(19) United States
(12) Patent Application Publication
(10) Pub. No.: US 2007/0107295 A1
(43) Pub. Date: May 17, 2007

(54) Artificial fishing lure with adjustable weight

(76) Inventor: Paul Kaptis, (US)

Correspondence Address: BRADLEY ARANT ROSE & WHITE LLP, 200 CLINTON AVE. WEST, SUITE 900, HUNTSVILLE, AL, 35801, US

(21) Appl. No.: 11/280,914

(22) Filed: Nov. 16, 2005

(51) Int. Cl. A01K 85/00

(52) U.S. Cl. 43/42.22; 43/42.39; 43/42.47

(57) ABSTRACT

An artificial fishing lure with an adjustable weight has been developed. The artificial fishing lure includes a body with a hollow slot. A weight is inserted into the slot to control the buoyancy of the lure. The weight may be removed and replaced with a larger or smaller weight as desired.

### BACKGROUND OF INVENTION

1. Field of the Invention

The invention relates generally to fishing equipment. More specifically, the present invention relates to an artificial fishing lure with adjustable weight.

2. Background Art

Various types of artificial baits are popular among sport fishermen. One type of bait is commonly called a “crank bait”. A crankbait is an artificial lure that typically floats on or near the top of the water. The lure has a “diving bill” protruding from its nose that typically serves as an attachment point for the fishing line. The diving bill forces the bait under the surface of the water as the user reels in the line.

Crank baits usually are weighted with a fixed weight such as a ball bearing that is internal to the body of the lure. This weight serves to provide ballast to the lure so that it may maintain an upright orientation in the water. The weight is not enough to submerge to lure beneath the water. When the lure is being retrieved, the depth of the lure is controlled by the rate of retrieval. Generally, the faster the user retrieves the lure, the deeper it dives. However, there may be times when a slow retrieval rate is desired in combination with a deep presentation of the lure. Consequently, a crankbait with an adjustable weight is needed.

### SUMMARY OF INVENTION

In some aspects, the invention relates to an artificial fishing lure, comprising: a body that contains a hollow slot; and a weight that is removably inserted into the slot to affect the buoyancy of the lure.

In other aspects, the invention relates to an artificial fishing lure, comprising: a body that contains a hollow slot; and means for inserting a removable weight into the hollow slot in order to affect the buoyancy of the lure.

In other aspects, the invention relates to an artificial fishing lure, comprising: a body that contains a slot that opens into a hollow chamber in the interior of the body; and a plug that fits into the slot to seal the hollow chamber.

In other aspects, the invention relates to an artificial fishing lure, comprising: a body that contains an accessible hollow chamber in the interior of the body; and means for inserting at least one bead into the hollow chamber to affect the buoyancy of the lure.

Other aspects and advantages of the invention will be apparent from the following description and the appended claims.

### BRIEF DESCRIPTION OF DRAWINGS

It should be noted that identical features in different drawings are shown with the same reference numeral.

FIG. 1 shows a cross-sectional view of a lure with an adjustable weight in accordance with one embodiment of the present invention.

FIG. 2 shows a cross-sectional view of a lure with an adjustable weight in accordance with an alternative embodiment of the present invention.

FIGS. 3a and 3b show overhead and side views of an adjustable weight in accordance with one embodiment of the present invention.

FIG. 4 a side view of a sleeve in accordance with one embodiment of the present invention.

FIGS. 5a and 5b show cross-sectional views of a lure with a hollow chamber with rattle-weights in accordance with alternative embodiments of the present invention.

FIG. 6 shows a detailed cross-sectional view of a hollow chamber and plug.

### DETAILED DESCRIPTION

An artificial fishing lure with an adjustable weight has been developed.

The present invention includes a crankbait that contains a removable weight that is located internally within its body. The weight may be removed and replaced with a larger or smaller weight as desired. A crankbait is an artificial fishing lure that floats at or near the surface of the water. As it is retrieved, it submerges to a depth that is directly related to the rate of retrieval. The crankbait may have a fixed weight, such as a ball bearing, that is permanently embedded within the body of the lure to provide ballast and orientation of the lure. A crankbait may be made of various buoyant materials such as plastic or wood.

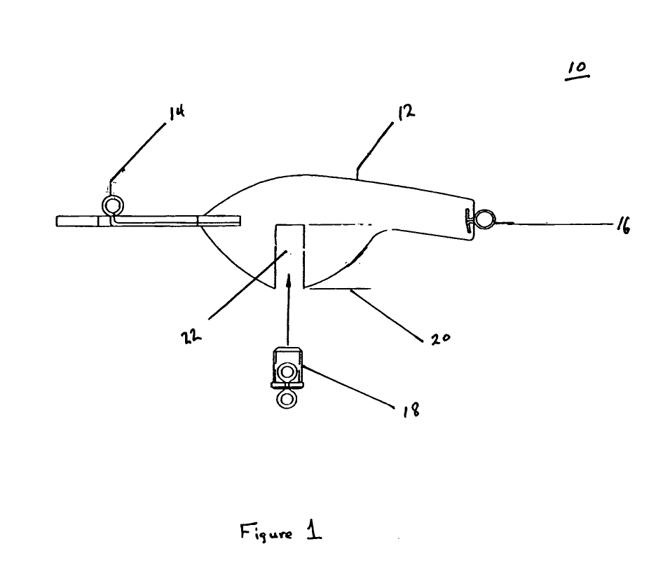

FIG. 1 shows an example of a plastic lure with an adjustable weight 10.

The lure 10 has a body 12 with a diving bill 14 and a rear eyelet 16. The diving bill 14 has an eyelet to attach to the fishing line. As the lure is retrieved, the diving bill 14 forces the lure 10 to submerge. A hook (not shown) is attached to the rear eyelet 16. The hook is usually a “treble hook” which is grouping of three separate barbs around a single stem.

The adjustable weight 18 is inserted into the interior of the body 12 of the lure. It may be held in place by friction or by screw threads (not shown). The weight 18 as shown includes an eyelet to allow the user to insert and remove the weight 18 as desired. A treble hook may be attached to this eyelet. The addition of this weight forces the lure to submerge instead of floating at or near the surface. This allows the user to make a presentation of the lure at a greater depth without increasing the retrieval rate. Other weights of lesser or greater size may be used since the adjustable weight is removable. In the example shown, the depth 20 of the slot 22 is 0.59 inches. The weight 18 shown in this example has a length of 0.19 inches and will not extend all the way to the end the slot when fully inserted into the lure. However, a heavier weight may use up the remaining space in the slot 22 as needed.

The weight may be made of heavy metals such as tungsten, lead or other similar materials. The actual weights may vary in mass from 3 to 20 grams in the examples shown. However, other size weights outside this range may be used in other embodiments of the invention. In other embodiments the weight and the slot may be threaded so that the weight may be screwed in or out of the lure. In the examples shown, the weight uses 10/32 inch threads (not shown).

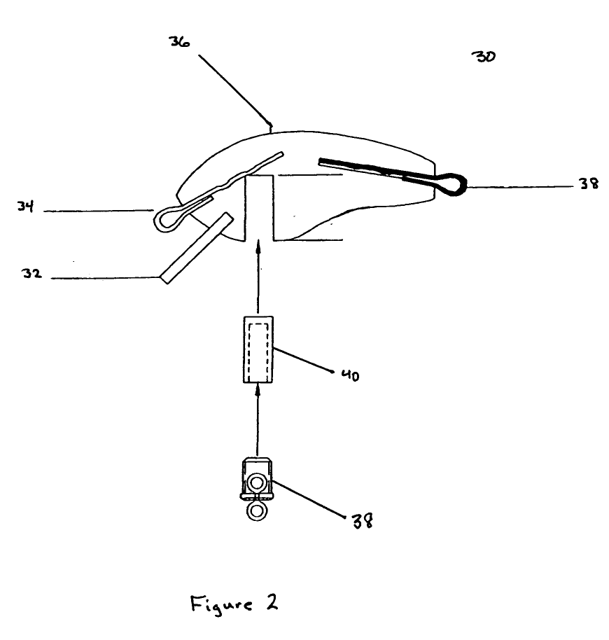

FIG. 2 shows a cross-sectional view of another example of the present invention. In this embodiment 30, the diving bill 32 is separate from the front eyepin 34 that attaches to the fishing line. Also shown is rear eyepin 38 that is inserted into the rear of the body 36 of the lure 30. The eyepins shown in FIG. 2 differ from the eyelets shown in FIG. 1 in that they have an elongated stem that extends more deeply into the body 36 of the lure 30.

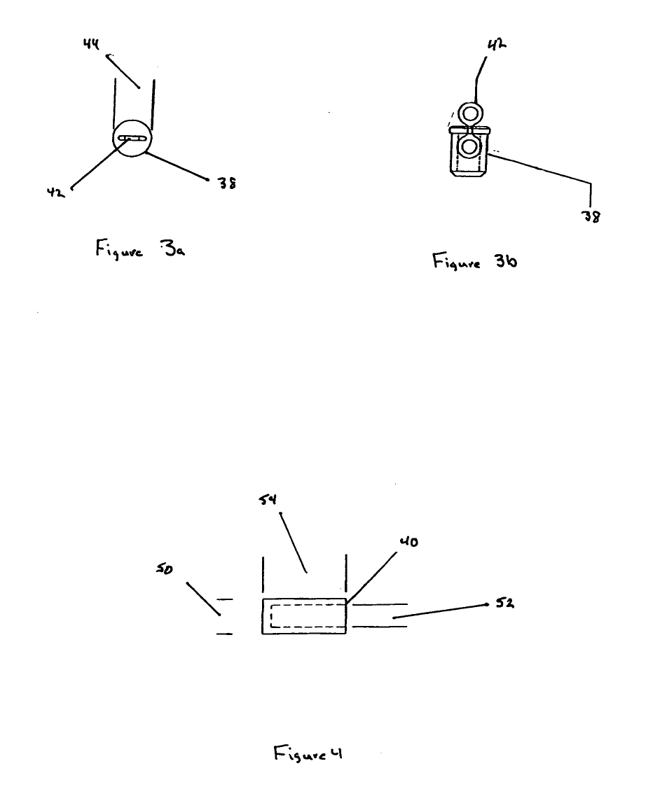

An adjustable weight 38 is used as previously shown in FIG. 1. However in the embodiment, a sleeve 40 is inserted into the slot 42 of the body 36 of the lure 30. The weight 38 is then inserted into the sleeve 40. The sleeve 40 may be removable or permanently mounted in the lure 30. FIGS. 3a and 3b show overhead and side views of the adjustable weight 38 and its eyelet 42. In this example, the weight has a hexagonal shaped body with a circular head at the top. The circular head has a circular diameter 44 of 0.28 inches. The width of the hexagonal body is 3/16 inches. In other embodiments, the body of the weight may be threaded. If a larger weight is needed, the length of the body is increased to add more material to be inserted into the lure.

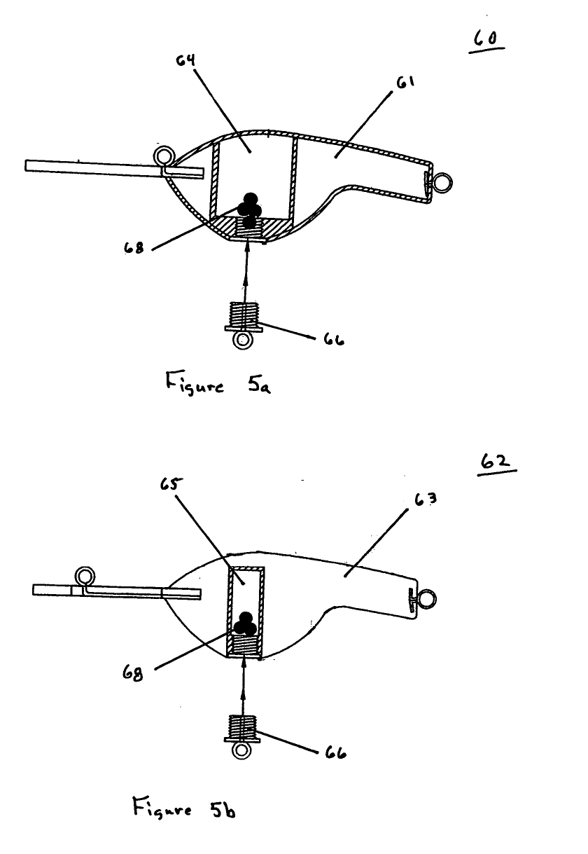

FIG. 4 shows a view of the sleeve 40 that fits inside the slot 42 as shown previously in FIG. 2. In this example, the sleeve 40 has an exterior diameter 50 of 0.4765 inches and an interior diameter 52 of 0.35 inches. The length of the sleeve 50 is 1.06 inches. If a threaded weight is used, the interior of the sleeve 40 will also be threaded. It should be understood that these dimensions are provided as an example. Alternative embodiments could use different dimensions, materials and arrangements of components of an artificial lure.

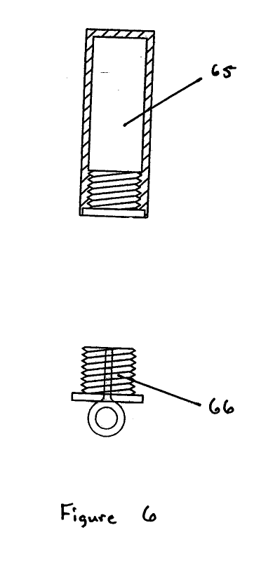

In alternative embodiments, the artificial lure could have a hollow interior chamber in the body of the lure. Instead of the weight being directly inserted into the body, weights are placed in the hollow chamber and the chamber is sealed with a plug. FIGS. 5a and 5b shows cross-sectional views 60 and 62 of a lure with a hollow chamber and rattle-weights in accordance with alternative embodiments of the present invention.

In both of these examples, a hollow chamber 64 and 65 is located in the body 61 and 63 of the lure. The chambers 64 and 65 are sealed with a plug 66 that is similar to the adjustable weights described previously in that they may be screwed into place. For adding weight to the lure, small individual weights 68 such as pellets, beads, etc. are placed in the chamber 64 and 65. The number of weights 68 may be varied as required to affect the buoyancy of the lure.

Since the weights 68 are loose inside the chamber 64 and 65, they have the additional advantage of making a “rattle” as the lure is retrieved. In other embodiments, the “weights” may be made of a very light material such as plastic so as not to affect the buoyancy of the lure. Instead, the plastic “weights” simply add more rattle to the lure without any increase in buoyancy.

In FIG. 5a, a larger chamber 66 is shown that is capable of holding a large number of weights. FIG. 5b shows a smaller chamber 65 that holds only a few weights. FIG. 6 shows a detailed view of the smaller chamber 65 along with the plug 66. In these examples, a larger chamber 66 will enable a louder and more distinct rattle sound to emanate from the lure.

While the invention has been described with respect to a limited number of embodiments, those skilled in the art, having benefit of this disclosure, will appreciate that other embodiments can be devised which do not depart from the scope of the invention as disclosed here. Accordingly, the scope of the invention should be limited only by the attached claims.

1-11. (canceled)

12. An artificial fishing lure, comprising:
a body that contains a slot that opens into a hollow chamber in the interior of the body; and
a removable weighted plug that fits into the slot to seal the hollow chamber, where the removable weighted plug is inserted into the slot to affect the buoyancy of the lure.

13. The artificial fishing lure of claim 12, further comprising:
at least one bead that is placed inside the sealed hollow chamber.

14. The artificial lure of claim 13, where the at least one bead inside the sealed hollow chamber affects the buoyancy of the lure.

15. The artificial lure of claim 14, where the at least one bead is made of tungsten.

16. The artificial lure of claim 14, where the at least one bead is made of lead.

17. The artificial lure of claim 12, where the artificial lure is made of a buoyant material.

18. The artificial fishing lure of claim 17, where the buoyant material is plastic.

19. The artificial fishing lure of claim 17, where the buoyant material is wood.

20. An artificial fishing lure, comprising:
a body that contains an accessible hollow chamber in the interior of the body; and
means for removably inserting a removable weighted plug into the hollow chamber to affect the buoyancy of the lure.

21. An artificial fishing lure, comprising:
a body that contains an accessible hollow chamber in the interior of the body;
means for inserting a removable weighted plug into the hollow chamber to affect the buoyancy of the lure; and
means for removably inserting at least one bead into the hollow chamber to affect the sound of the lure.
